(19) United States
(12) Patent Application Publication
(10) Pub. No.: US 2013/0161317 A1
(43) Pub. Date: Jun. 27, 2013

(54) INDUCTION HEATING COOKER AND CONTROL METHOD THEREOF

(71) Applicants: Se Min Lee, Yongin-si (KR); Kil Young Lee, Hwaseong-si (KR); Kyung Suk Bae, Suwon-si (KR); Seong Deog Jang, Suwon-si (KR)

(72) Inventors: Se Min Lee, Yongin-si (KR); Kil Young Lee, Hwaseong-si (KR); Kyung Suk Bae, Suwon-si (KR); Seong Deog Jang, Suwon-si (KR)

(73) Assignee: Samsung Electronics, Co., Ltd., Suwon-si (KR)

(21) Appl. No.: 13/355,033

(22) Filed: Jan. 20, 2012

(30) Foreign Application Priority Data
Dec. 23, 2011 (KR) 10-2011-0141335

(51) Int. Cl. H05B 6/12

(52) U.S. Cl. 219/620

(57) ABSTRACT

An induction heating coil including a heating coil, an inverter unit configured to provide a high-frequency power to the heating coil, a driving unit configured to provide a signal used to control an operation of the inverter unit, a operation unit including a water boiling button configured to select a water boiling function, and a control unit configured, if a water boiling function selection signal is input through manipulation of the water boiling button, to vary an operating frequency of the driving unit based on an output of the heating coil, and to determine whether water contained in a vessel placed on the heating coil is boiling by use of a difference between the operating frequencies that is calculated at a predetermined period of time, so that the water boiling or the food boiling is detected during boiling water or cooking foods.

### CROSS-REFERENCE TO RELATED APPLICATIONS

This application claims the benefit of Korean Patent Application No. 2011-0141335, filed on Dec. 23, 2011 in the Korean Intellectual Property Office, the disclosure of which is incorporated herein by reference.

### BACKGROUND

1. Field

Embodiments of the present disclosure relate to an induction heating cooker having a water boiling function.

2. Description of the Related Art

In general, an induction heating cooker is an apparatus configured to cook foods by supplying a high-frequency current to a heating coil to generate a high-frequency magnetic field and by causing eddy currents in a cooking vessel (hereinafter referred to as a vessel), which has a magnetic coupling with the heating coil through the generated magnetic field, such that the vessel is heated by Joule's heat generated through the eddy current.

Inside a body that forms an external appearance of an induction heating cooker, a plurality of heating coils is fixed to the body to provide a heat source. In addition, a cooking plate is provided on the body such that a vessel is placed on the cooking plate. A cooking zone is defined on a predetermined position of the cooking plate corresponding to the heating coil. The cooking zone serves to guide to a position where a vessel is to be placed when cooking foods.

When a user boils water and cooks food (such as broth, soup or stew) that contains a large amount of water, and leaves the water or the food on a cooking plate too long without paying attention, the water boils over, and the vessel is overheated. Accordingly, there is a need to adjust the output of a power of a heating coil.

A conventional induction heating cooker having an automatic output adjusting function is implemented as follows. First, a user inputs a desired output level after manipulating an automatic output adjusting function key (hereinafter referred to as a “function key”). A heating coil operates at a maximum output level for a preset time (representing the time set for maximum output) that is set to correspond to the desired output level, and then the heating coil is driven at the desired output level.

For example, referring to FIG. 1A, a user may input a desired output at level 2 after manipulating a function key. The heating coil operates at the maximum output level (P) for a preset time of 1 minute, that is preset according to the level 2, and then the heating coil automatically adjusts its output to the level 2. For example, referring to FIG. 1B, if a user may input a desired output level at level 9 after manipulating a function key, the heating coil operates at the maximum output level (P) for a preset time of 8 minutes, that is preset according to the level 9, and then the heating coil automatically adjusts its output to the level 9.

As described above, the adjusting of output of the heating coil is not achieved by detecting the actual water boiling, but is automatically achieved based on a lapse of the time set for maximum output that is preset on a program. Accordingly, the output of the heating coil is adjusted regardless of an actual state of contents in a vessel. That is, if the time set for maximum output elapses even before the water or food is boiling in a vessel, this makes the output level of the heating coil to be turned down, thereby failing to cook the food. In addition, the time set for maximum output does not elapse even if the water or food is boiling in a vessel, the heating coil maintains its output level at the maximum output level, thereby causing water or food to boil up or causing the vessel to be overheated.

### SUMMARY

Therefore, it is an aspect of the present disclosure to provide an induction heating cooker and a control method thereof, capable of detecting about boiling water or food that contains water during cooking by use of an operating frequency of a driving unit that is configured to provide a signal used to control the operation of an inverter.

It is another aspect of the present disclosure to provide an induction heating cooker and a control method thereof, in which an output level of a heating coil is adjusted after detecting whether water or food that contains water is boiling during cooking, thereby preventing the water or the food from boiling up or preventing a vessel from being overheated.

Additional aspects of the disclosure will be set forth in part in the description which follows and, in part, will be apparent from the description, or may be learned by practice of the disclosure.

In accordance with one aspect of the present disclosure, an induction heating cooker includes a heating coil, an inverter unit, a driving unit, an operation unit and a control unit. The inverter unit is configured to provide a high-frequency power to the heating coil. The driving unit is configured to provide a signal used to control an operation of the inverter unit. The operation unit includes a water boiling button configured to select a water boiling function. The control unit is configured, if a water boiling function selection signal is input through manipulation of the water boiling button, to vary an operating frequency of the driving unit based on an output of the heating coil, and to determine whether water contained in a vessel placed on the heating coil is boiling by use of a difference between the operating frequencies that is calculated at a predetermined period of time.

The control unit determines that the water contained the vessel is boiling, if a difference between the operating frequencies is equal to or below a predetermined value.

The predetermined value corresponds to a difference between the operating frequencies obtained when water is boiling.

The control unit turns down an output level of the heating coil by transmitting a control signal to the driving unit if it is determined that the water contained in the vessel is boiling.

The control unit stops operating the heating coil by transmitting a control signal to the driving unit if it is determined that the water contained in the vessel is boiling.

The induction heating cooker further includes a detection unit configured to detect an electric current value flowing through the heating coil, wherein the control unit varies the operating frequency of the driving unit based on the detected electric current value.

In accordance with another aspect of the present disclosure, a method of controlling an induction heating cooker is provided. The induction heating cooker includes a heating coil, an inverter unit configured to provide a high-frequency power to the heating coil and a driving unit configured to provide a signal used to control an operation of the inverter unit. The method is as follows. A high-frequency power is provided to the heating coil if a water boiling function selecting signal is input. A value of an electric current flowing through the heating coil is detected. An operating frequency of the driving unit is varied based on the detected electric current value. A difference between the operating frequencies is calculated at a predetermine period of time. It is determined whether water contained in a vessel placed on the heating coil is boiling by use of a difference between the operating frequencies.

In the determining whether water contained in the vessel is boiling, it is determined that water contained in the vessel is boiling if a difference between the operating frequencies is equal to or below a predetermined value.

The predetermined value corresponds to a difference between the operating frequencies obtained when water is boiling.

The method further includes turning down an output level of the heating coil by transmitting a control signal to the driving unit if it is determined that the water contained in the vessel is boiling.

The method further includes stopping operation of the heating coil by transmitting a control signal to the driving unit if it is determined that the water contained in the vessel is boiling.

The method further includes notifying a user that the water contained in the vessel is boiling.

As described above, according to an embodiment of the present disclosure, it is detected whether the water or the food containing water is boiling during cooking by use of an operating frequency of a driving unit that is configured to provide a signal used to control the operation of an inverter.

In addition, an output level of a heating coil is adjusted after detecting whether the water or the food containing water is boiling during cooking, thereby preventing the water or the food from boiling up or preventing a vessel from being overheated.

### BRIEF DESCRIPTION OF THE DRAWINGS

These and/or other aspects of the disclosure will become apparent and more readily appreciated from the following description of the embodiments, taken in conjunction with the accompanying drawings of which:

FIGS. 1A and 1B are views used to explain the concept of an automatic output adjustment function that is implemented in a conventional induction heating cooker.

FIG. 2 is a perspective view illustrating an external appearance of an induction heating cooker according to an embodiment of the present disclosure.

FIG. 3 is a control block diagram of an induction heating cooker according to an embodiment of the present disclosure.

FIGS. 4A and 4B are views used to explain the concept of a water boiling function that is implemented in an induction heating cooker according to an embodiment of the present disclosure.

FIG. 5A is a graph showing a characteristic curve of output level variation according to time when water boils.

FIG. 5B is a graph showing the relationship between the operating frequency of a driving unit and the output level of a heating coil.

FIG. 6A is a graph showing a characteristic curve of water temperature variation according to time when water boils.

FIG. 6B is a graph showing the difference between the operating frequencies of a driving unit according to time when water boils.

FIG. 7 is a flowchart showing a control method of an induction heating cooker according to an embodiment of the present disclosure.

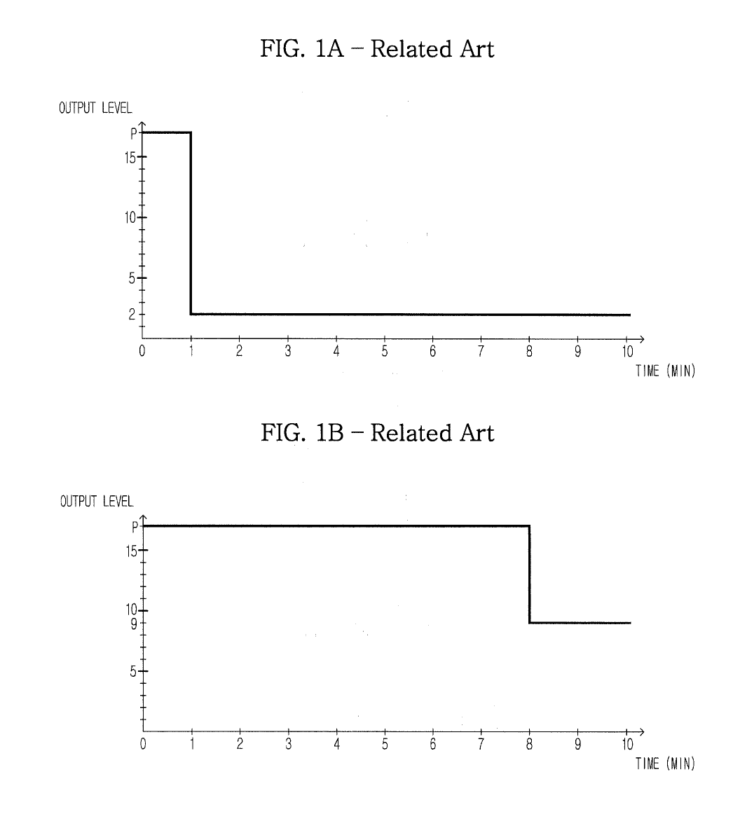

### DETAILED DESCRIPTION

Reference will now be made in detail to the embodiments of the present disclosure, examples of which are illustrated in the accompanying drawings, wherein like reference numerals refer to like elements throughout.

For convenience sake of description, it is understood that “output level” represents “an output level of a heating coil” that is set by a user, for example, an output level ranging from level 1 to level 15 and also represents “an output power corresponding to an output level of a heating coil”. For example, if an output power corresponding to output level 5 is 600 W, when a heating coil operates with an output level 5, it is understood that the heating coil operates with an output power of 600 W corresponding to the output level 5.

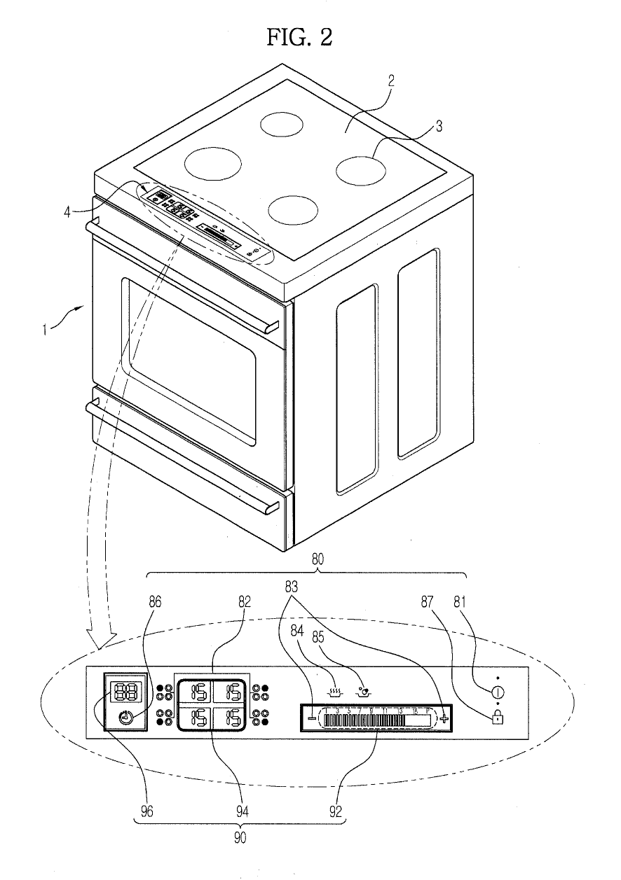

FIG. 2 is a perspective view illustrating an external appearance of an induction heating cooker according to an embodiment of the present disclosure.

Referring to FIG. 2, an induction heating cooker according to an embodiment of the present disclosure includes a body 1.

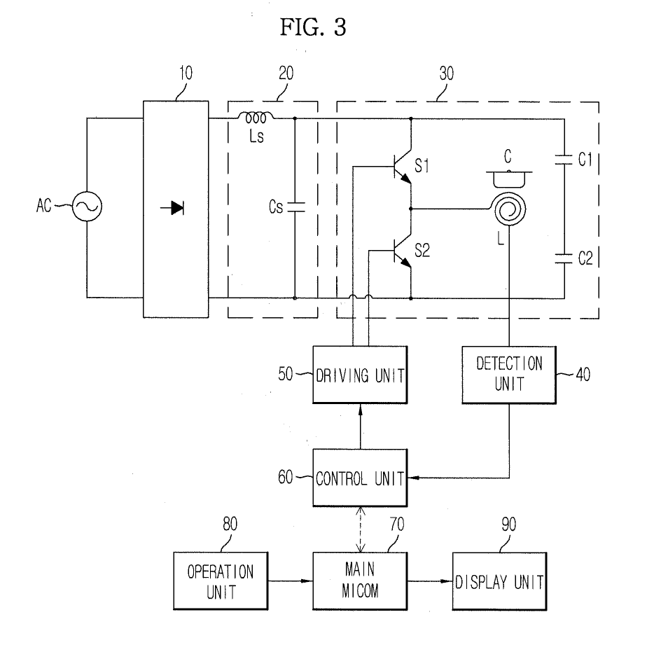

The body 1 is provided at an upper portion thereof with a cooking plate 2. The cooking plate 2 is provided in a flat shape enabling a vessel (denoted as C in FIG. 3) to be placed thereon. The cooking plate 2 includes reinforcing glass such as ceramic glass that is strong against brittleness or scratch. A cooking zone 3 is defined on the cooking plate 2 to guide into a position where the vessel (C) is placed when a user cooks foods.

A plurality of heating coils (denoted as L, in FIG. 3) is installed below the cooking plate 2 inside the body 1 to provide the cooking plate 2 with a heating source. Each of the heating coils (L) is disposed on a place corresponding to the cooking zone 3. That is, one heating coil is disposed to correspond to one cooking zone. In FIG. 2, the description is made in relation to the induction heating cooker having four cooking zones 3 as an example. However, the number of cooking zones of the induction heating cooker is not limited thereto.

In addition, the body 1 is provided at an upper portion with a control panel 4 including an operation unit 80 and a display unit 90. The operation unit 80 includes a plurality of manipulating buttons used to input various commands about cooking functions. The display unit 90 displays information related to operations of the induction heating cooker.

The operation unit 80 includes a power ON/OFF button 81, a cooking zone selecting button 82, an adjustment (+/−) button 83, a keep-warm button 84, a water boiling button 85, a timer button 86, and a lock button 87. The power ON/OFF button 81 is configured to power on/off. The cooking zone selecting button 82 is configured to select the cooking zone 3 desired by a user for cooking. The adjustment (+/−) button 83 is configured to set a cooking time. The keep-warm button 84 is configured to select a temperature keeping function of keeping a predetermined temperature (for example, 60 to 70) to prevent a cooked food from getting cold. The timer button 86 is configured to select a safety shutoff function of stopping a cooking operation after a lapse of a preset time that is set by a user. The lock button 87 is configured to select a lock function that prevents children from operating button when a cooking is not performed or prevents other buttons except for the power ON/OFF button 81 when a cooking is performed.

In addition, the display unit 90 includes a first display window 92, a second display window 94, and a third display window 96. The first display window 92 displays an output level of a heating coil (L) which is being set through the adjustment (+/−) button 83. The second display window 94 displays an output level of a heating coil (L) which has been set for each cooking zone 3. The third display window 96 displays a lock function setting, such as displaying a letter “L” when a locking function is set, and displays a cooking time that is set through the adjustment (+/−) button 83.

The output level of the heating coil (L) that can be set through the adjustment (+/−) button 83 includes stepwise output levels ranging from level 1 to level 15 and a maximum output level (P). The maximum output level (P) corresponds to an output level along with selecting a power boost function. The boot function represents a function of generating a high power in a short time to cook foods quickly.

Hereinafter, the maximum output level (P) represents an output level specified according to selecting the power boost function.

FIG. 3 is a control block diagram of an induction heating cooker according to an embodiment of the present disclosure. Although the induction heating cooker is described as having four cooking zones 3 in FIG. 2, the configuration of control components to operate each heating coil (L) corresponding to each cooking zone 3 is same, and FIG. 3 describes only one unit of control components used to operate one heating coil L. Accordingly, following descriptions will be made in relation to one unit of control component used to operate one of the four heating coils L in detail, and descriptions of control components for remaining three heating coils will be omitted.

Referring to FIG. 3, the induction heating cooker according to an embodiment of the present disclosure includes a rectifier unit 10, a smoothing unit 20, an inverter unit 30, a detection unit 40, a driving unit 50, a control unit 60, a main micom (microcomputer) 70, the operation unit 80, and the display unit 90.

The rectifier unit 10 is configured to perform rectification on an input alternating current (AC) power to output a ripple voltage.

The smoothing unit 20 is configured to smooth the ripple voltage provided from the rectifier unit 10 to output a constant Direct Current voltage.

The inverter unit 30 includes switching devices (S1 and S2) and resonant capacitors (C1 and C2). The switching devices (S1 and S2) switch a direct current voltage, which is received from the smoothing unit 20, according to a switching control signal of the driving unit 50, thereby providing a resonant voltage. The resonant capacitors (C1 and C2) are connected in series with one another between a positive supply terminal and a negative supply terminal to achieve a continuous resonance from an input voltage in cooperation with the heating coil L.

The heating coil (L) is connected between the switching devices S1 and S2 to heat the vessel (C) by inducing a vessel (C) to have an eddy current based on a resonant voltage that is input from the rectifier unit 10.

If the switching device (S1) is conducting and the switching device (S2) is non-conducting, the resonance capacitor (C2) and the heating coil L1 form a resonance circuit in series with each other. If the switching device (S2) is conducting and the switching device (S1) is non-conducting, the resonance capacitor (C1) and the heating coil L1 form a resonance circuit in series with each other.

The detection unit 40 detects a value of an electric current flowing through the heating coil L, and provides the detected electric current value to the control unit 60. The detection unit 40 according to this embodiment of the present disclosure may be implemented using a current transformer (CT) sensor.

The driving unit 50 outputs a driving signal to the switching device (S1 and S2) of the inverter unit 30 according to a control signal of the control unit 60 such that the switching devices (S1 and S2) is switched on or off.

The control unit 60 controls the operation of the heating coil (L) by transmitting a control signal to the driving unit 50 according to a control signal of the main micom 70. Upon reception of a cooking initiation control signal from the main micom 70, the control unit 60 allows the driving unit 50 to alternately generate a switching control signal that is configured to operate one of the switching devices (S and S2) at a time. If the switching device (S1) is conducting and the switching device (S2) is non-conducting, the switching device (S1), the heating coil (L) and the resonant capacitor (C2) form a circuit such that a resonant voltage is provided to the heating coil (L). If the switching device (S2) is conducting and the switching device (S1) is non-conducting, the resonant capacitor (C1), the heating coil (L) and the switching device (S2) form a circuit such that a resonant voltage is provided to the heating coil (L). In this manner, the heating coil (L) produces a continuous resonance in cooperation with each of the resonant capacitors (C1 and C2), so that a great resonant current flows through the heating coil (L).

The resonant current causes a high-frequency magnetic field on the heating coil (L). The high-frequency magnetic field induces the vessel (C) to have eddy current that heats the vessel (C), thereby cooking foods contained in the vessel (C).

The control unit 60 performs a water boiling function according to a control signal of the main micom 70. The control unit 60 receives a value of an electric current (an output current value) flowing through the heating coil (L) from the detection unit 40, and determines whether the output level of the heating coil (L) is lowered. In order to keep the output level of the heating coil (L) at the maximum output level before water contained in the vessel (P) is boiling, the control unit 60 varies the operating frequency of the driving unit 50 that provides a driving signal used to control the operation of the inverter unit 30.

In addition, the control unit 60 calculates a difference (fₜ−fₜ₋₁) in the operating frequencies of the driving unit 50 at a predetermined period of time: for example, every 30 seconds, starting from a point of time (t0) at which the vessel (C) is placed on the cooking zone 3 and a cooking, that is, water boiling starts.

If the difference between the operating frequencies of the driving unit 50 is equal to or below a predetermined value, the control unit 60 determines that the water contained the vessel (C) is boiling after the cooking starts, and turns down the output level of the heating coil (L) or stops operation of the heating coil (L). The predetermined value corresponds to a difference between the operating frequencies of the driving unit 50 obtained when water is boiling.

The control unit 60 includes an internal memory (not shown). The memory stores a reference value (the predetermined value), which is used to determine whether water contained in the vessel (C) is boiling, and a period of time (T) at which the operating frequency of the driving unit 50 is checked.

The main micom 70 controls the overall operation of the induction heating cooker. The main micom 70 is connected to the control unit 60, which is configured to control the operation of the heating coil (L), as to enable communication. The main micom 70 sends the control unit 60 a control signal such that the control unit 60 controls the operation of the heating coil (L).

Upon reception of a water boiling function selection signal through the operation unit 80, the main micom 70 sends the control unit 60 a control signal such that a water boiling function is performed.

The operation unit 80 is provided at the upper portion of the body of the induction heating cooker such that a user inputs commands related to various cooking function, for example, a power ON/OFF function and a water boiling function.

The display unit 90 displays the cooking status of the induction heating cooker, the output level of the heating coil (L) that is input by a user through the adjustment (+/−) button, and the cooking time according to a control signal of the main micom 70.

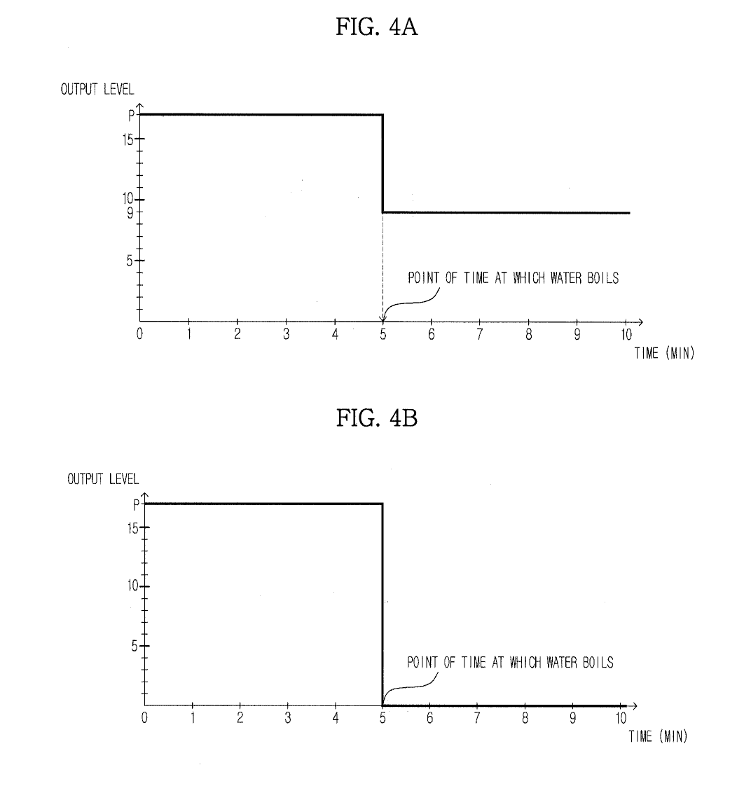

FIG. 4 is a view used to explain the concept of a water boiling function that is implemented in an induction heating cooker according to an embodiment of the present disclosure.

According to a technology of adjusting the output of the heating coil based on a lapse of a preset time, a heating coil operates with the maximum output level for a preset time, and then the heating coil automatically operates with a desired output level that is input by a user. Such a technology has a drawback in that the output of the heating coil is adjusted regardless of an actual state of contents in a vessel, that is, independent of that water is boiling in practice.

Different from the technology of adjusting the output of the heating coil based on a lapse of a preset time, the induction heating cooker according to the embodiment of the present disclosure adjusts the output of the heating coil (L) by detecting the water boiling when the water is boiling or the foods containing a large amount of water is cooked, thereby preventing the water or the food from boiling up or preventing a vessel from being overheated.

The induction heating cooker according to the embodiment of the present disclosure implements a water boiling function. Accordingly, if a user input a desired output level after manipulating the water boiling button 85, the output level of the heating coil (L) is automatically adjusted from the maximum output level, or the operation of the heating coil (L) is automatically stopped if a water boiling is detected during cooking.

For example, referring to FIG. 4A, if a user inputs a desired output level to level 9 after manipulating the water boiling button 85, the heating coil (L) operates at the maximum output level (P) until water in the vessel (C) is boils, and the output level of the heating coil (L) is automatically adjusted to the output level 9 input by the user if the water boiling is detected. Alternatively, referring to FIG. 4B, if a user does not input a desired output level after manipulating the water boiling button 85, the heating coil operates at the maximum output level (P) until water in the vessel (C) is boiling, and the operation of the heating coil is automatically stopped if the water boiling is detected.

Referring to FIGS. 4A and 4B, although the water boiling function is implemented in relation that the heating coil (C) operates at the maximum output level (P) until water in the vessel (C) is boiling, and if the water boiling is detected, the output of the heating coil (L) is adjusted to the output level input by the user or the operation of the heating coil (L) is stopped, the water boiling function is not limited thereto. Alternatively, the water boiling function is implemented in relation that the heating coil (C) operates with the maximum output level (P) until water in the vessel (C) is boiling, and if the water boiling is detected, the output of the heating coil (L) is adjusted to the minimum output level (level 1). Alternatively, the water boiling function is implemented in relation that the heating coil (C) operates with the desired output level (for example, level 10) set by a user until water in the vessel (C) is boiling, and if the water boiling is detected, the output level of the heating coil (L) is adjusted to a value lower than the output level set by the user (for example, level 5).

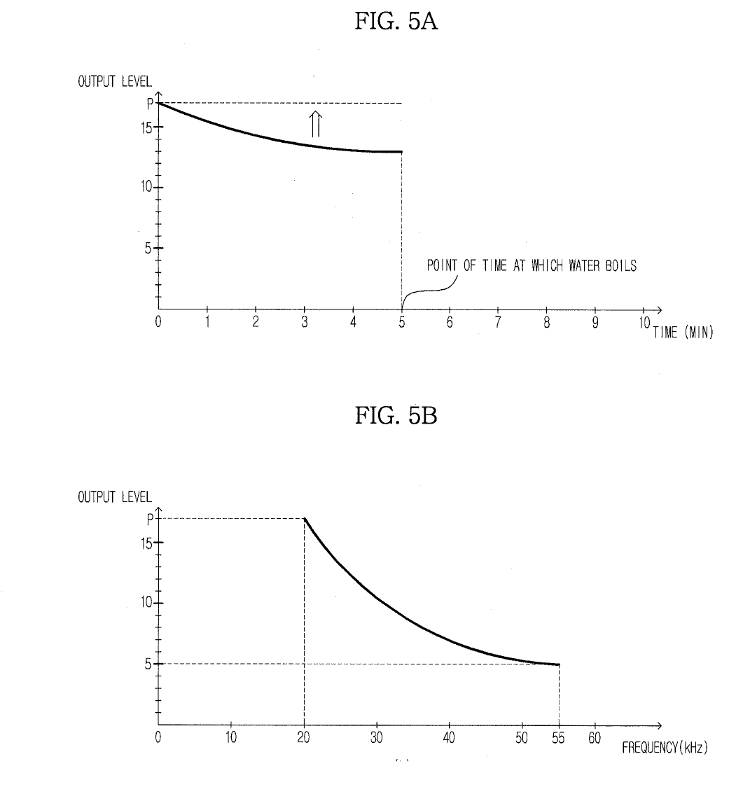

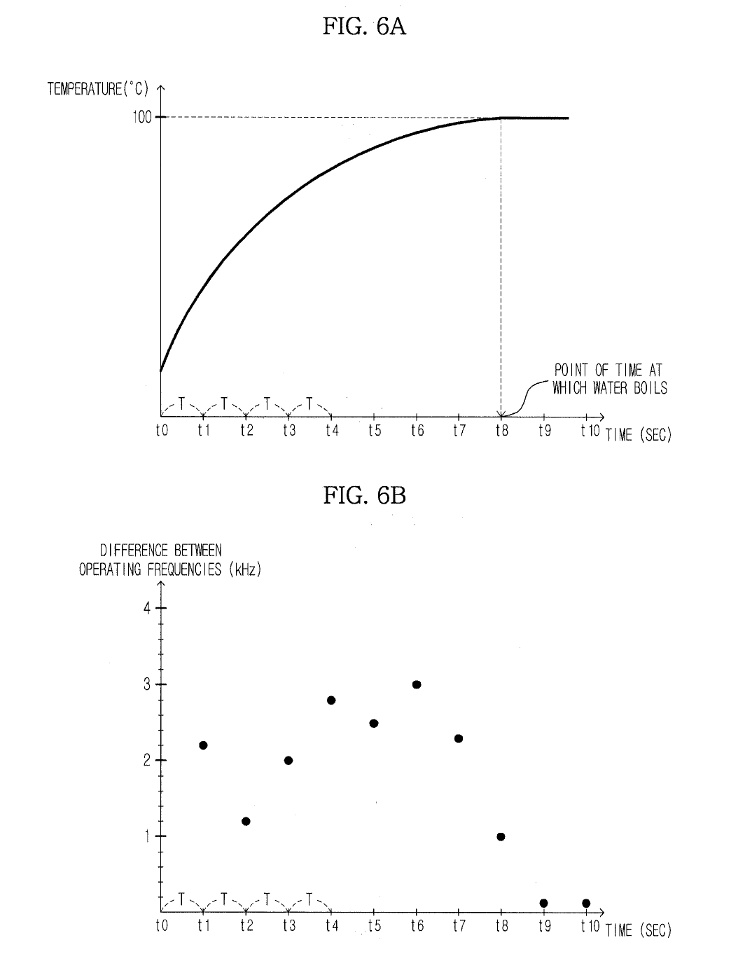

Hereinafter, a scheme of detecting about boiling water or food containing a large amount of water in the vessel (C) when a cooking is performed in the induction heating cooker according to an embodiment of the present disclosure is described with reference to FIGS. 5A, 5B, 6A and 6B.

In order for a user to boil water or food containing a large amount of water, if the user places a vessel (C) accommodating the water or the food on one of the four cooking zones 3, manipulates the cooking zone selecting button 82 and the water boiling button 85, and inputs a desired output level through the adjustment (+/−) button, the main micom 70 sends the control unit 60 a control signal such that the control unit 60 performs a water boiling function.

In performing the water boiling function according to the main micom 70, the control unit 60 sends the driving unit 50 a control signal such that a resonant voltage is provided to the heating coil (L). In this manner, the heating coil (L) produces a continuous resonance in cooperation with each of the resonant capacitors (C1 and C2), so that a great resonant current flows through the heating coil (L). The resonant current causes a high-frequency magnetic field on the heating coil (L). The high-frequency magnetic field induces the vessel (C) to have eddy current that heats the vessel (C), thereby cooking foods contained in the vessel (C).

Referring to FIG. 5A, as the cooking operation proceeds, that is, as time goes by, the temperature of the bottom of the vessel (C) increases and a magnetic field generated on the heating coil (L) is changed, and thus the output level of the heating coil (L) is lowered. The output level of the heating coil (L) being lowered and the extent to which the output level is lowered is determined by use of a value (output current value) of an electric current flowing through the heating coil (L).

As shown in an arrow of FIG. 5A, in order to maintain the output level of the heating coil (L) at the maximum output level (P) until water in the vessel (C) is boiling in practice, that is, until five minutes elapses after the cooking starts, the control unit 60 varies the operating frequency of the driving unit 50 configured to provide a driving signal used to control the operation of the inverter unit 30. Hereinafter, an operating frequency may be referred to as the operating frequency of the driving unit 50.

Referring to FIG. 5B, when viewed a relationship between the operating frequency of the driving unit 50 and the output level of the heating coil (L), the lower the operating frequency of the driving unit 50 is, the higher the output level of the heating coil (L) is, and the higher the operating frequency of the driving unit 50 is, the lower the output level of the heating coil (L) is. Accordingly, the control unit 60 lowers the operating frequency of the driving unit 50 to maintain the output level of the heating coil (L) at the maximum output level (P) until water in the vessel (C) is boiling in practice. Since the temperature of the bottom of the vessel (C) rises until water in the vessel (C) is boiling in practice, the operating frequency of the driving unit 50 gradually changes.

The control unit 60 checks the operating frequency of the driving unit 50 at an initiation point of time (t0) at which the vessel (C) is placed on the cooking zone 3 and a cooking, such as boiling water, gets started. The control unit 60 keeps checking the operating frequency of the driving unit 50, which varies with the rise of the temperature of the bottom of the vessel (C), at a predetermined period of time (T).

In addition, the control unit 60 calculates the difference (fₜ−fₜ₋₁) in the operating frequencies of the driving units at a predetermined period of time (T), for example, 30 seconds, from the initiation point of time (t0) at which the vessel (C) is placed on the cooking zone 3 and the cooking gets started. Herein, fₜ represents the operating frequency of the driving unit 50 at a current time, and fₜ₋₁ represents the operating frequency of the driving unit 50 at one period (T) prior to the current time.

Referring to FIG. 6A, when viewed the temperature change characteristic of water according to time when water is boiling, the temperature of water continuously rises until the temperature reaches to 100° C. corresponding to the boiling point of water and remains at 100° C. without rising

Since the temperature of water continuously rises over the ranges of time t0 to t8 before water is boiling, the temperature of the bottom of the vessel (C) also gradually rises. Accordingly, the operating frequency of the driving unit 50 is continuously changed, and thus the difference (fₜ−fₜ₋₁) between the operating frequencies of the driving unit 50 exceeds a predetermined value.

Meanwhile, after the water is boiling at a point of time t8, the temperature of water does not rise, and thus the temperature of the bottom of the vessel (C) keeps a constant temperature. Accordingly, the operating frequency of the driving unit 50 keeps a substantially constant value, and thus the difference (fₜ−fₜ₋₁) between the operating frequencies of the driving unit 50 is near to 0.

Referring to FIG. 6B, when viewed the difference between the operating frequencies of the driving unit 50 according to time when water is boiling, the difference between the operating frequencies of the driving unit 50 is larger than a predetermined value, for example, 0.2, over the ranges of time t0 to t8. If an operating frequency of the driving unit 50 at a point of time t1 is f1 and an operating frequency of the driving unit 50 at a point of time t0 that is one period prior to the time t1 is f0, the difference (f₁−f₀) between the operating frequencies calculated at the point of time t1 is 2.2 kHz. If an operating frequency of the driving unit 50 at a point of time t2 is f2 and an operating frequency of the driving unit 50 at a point of time t1 that is one period prior to the time t2 is f1, the difference (f₂−f₁) between the operating frequencies calculated at the point of time t2 is 1.2 kHz. Analyzing the graph of FIG. 6B in this manner, the difference (f₃−f₂) between the operating frequencies calculated at the point of time t3 is 2 kHz, the difference (f₄−f₃) between the operating frequencies calculated at the point of time t4 is 2.8 kHz, the difference (f₅−f₄) between the operating frequencies calculated at the point of time t5 is 2.5 kHz, the difference (f₆−f₅) between the operating frequencies calculated at the point of time t6 is 3 kHz, the difference (f₇−f₆) between the operating frequencies calculated at the point of time t7 is 2.3 kHz, and the difference (f₈−f₇) between the operating frequencies calculated at the point of time t8 is 1 kHz. As described above, the difference (fₜ−fₜ₋₁) between the operating frequencies does not increase/decrease in a regular manner but increases/decreases irregularly. This is because the temperature of the bottom of the vessel (C) may rise irregularly at each period of time (t0 to t1, t1 to t2 . . . ) even if the output level of the heating coil (L) is compensated by varying (lowering) the operating frequency of the driving unit 50, the difference (fₜ−fₜ₋₁) between the operating frequencies of the driving unit 50 calculated at each point of time (t1 to t8) fluctuates.

Meanwhile, referring to FIG. 6B, the operating frequency over the ranges of time t8 to t10 is equal to or below a predetermined value, for example, 0.2. If an operating frequency of the driving unit 50 at a point of time t9 is f9 and an operating frequency of the driving unit 50 at a point of time t8 that is one period prior to the time t9 is f8, the difference (f₉−f₈) between the operating frequencies calculated at the point of time t9 is 0.1 kHz. If an operating frequency of the driving unit 50 at a point of time t10 is f10 and an operating frequency of the driving unit 50 at a point of time t9 that is one period prior to the time t10 is f9, the difference (f₁₀−f₉) between the operating frequencies calculated at the point of time t10 is 0.1 kHz. That is, the difference (fₜ−fₜ₋₁) between the operating frequencies of the driving unit 50 calculated at each point of time t9 and t10 is near to 0.

The control unit 60 detects a water boiling at the point of time t9 at which the difference between the operating frequencies of the driving unit 50 starts to be lower a predetermined value, for example, 0.2. The control unit 60 determines the time t8 as the point of time at which water starts boiling in practice. The difference of the operating frequencies of the driving unit is calculated to be near to 0 at two points of time t9 and t10, and this result makes the control unit 60 to detect a water boiling. After the point of time t10, the control unit 60 does not check the operating frequency of the driving unit 50.

A value corresponding to the difference between the operating frequencies of the driving unit 50 in a state that water is boiling is stored in the internal memory of the control unit 60 (hereinafter, the value will be referred to as a predetermined value). If the difference between the operating frequencies of the driving unit 50 is equal to or below the predetermined value after initiation of a cooking, such as boiling water, the water boiling is detected, and thus the output level of the heating coil (L) is automatically turned down or the operation of the heating coil (L) is automatically stopped.

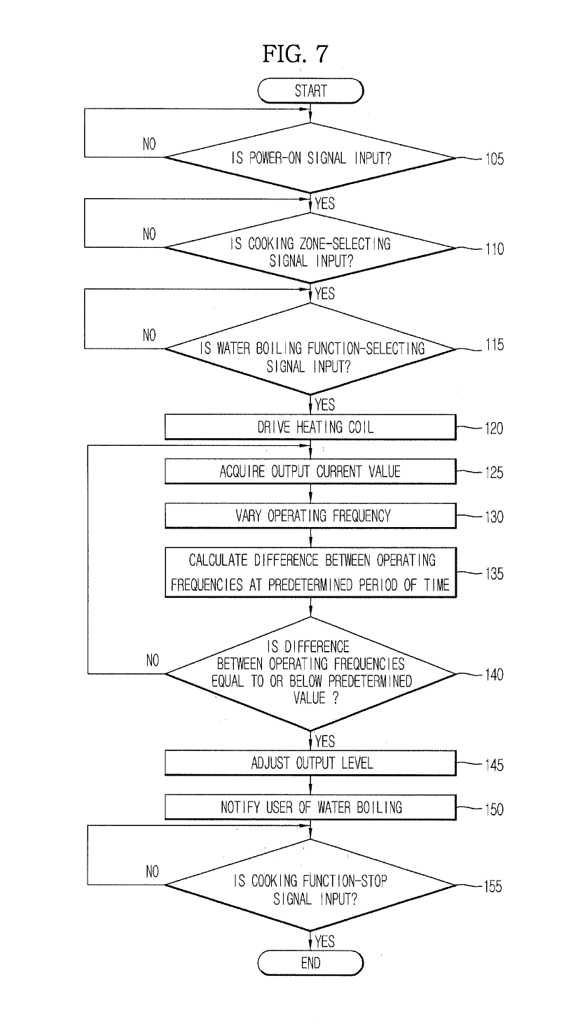

Hereinafter, a control method of an induction heating cooker according to an embodiment of the present disclosure will be described with reference to FIG. 7.

It is assumed that the memory of the control unit 60 stores a reference value (a predetermined value) used to determined whether water in the vessel (C) is boiling, and a period of time at which the operating frequency of the driving unit 50 is checked as an initial condition for operating the embodiment of the present disclosure.

First, the main micom 70 determines whether a power ON/OFF signal is input by a user through the manipulation of the power ON/OFF button 81 (105).

If the power ON signal is input by the user through the manipulation of the power ON/OFF button 81 corresponding to “yes” in operation 105, the main micom 70 turns on the induction heating cooker and waits for a cooking zone selecting signal to be input by a user through the manipulation of the cooking zone selecting button 82 (110).

If the cooking zone selecting signal is input by the user through the manipulation of the cooking zone selecting button 82 corresponding to “yes” in operation 110, the main micom 70 transmits the cooking zone selecting signal to the control that is configured to control the operation of the heating coil (L), and determines whether a water boiling function selecting signal is input by the user through the manipulation of the water boiling button 85 (115).

If the water boiling function selecting signal is input by the user through the manipulation of the water boiling button 85 corresponding to “yes” in operation 115, the main micom 70 transmits a water boiling function executing the command to the control unit 60 that is configured to control the operation of the heating coil (L).

The control unit 60 having received the water boiling function executing the command transmits a control signal to the driving unit 50, which controls the operation of the heating coil (L) disposed at a position corresponding to the cooking zone that is selected by the user, thereby driving the corresponding heating coil (L) (120).

Thereafter, the control unit 60 acquires a value of an electric current flowing through the heating coil (L) from the detection unit 40 (125). The control unit 60 determines whether the output level of the heating coil (L) is lowered based on the output current value acquired, and varies the operating frequency of the driving unit 50 such that the output level of the heating coil (L) is maintained at the maximum output level until water in the vessel (C) is boiling in practice (130).

Then, the control unit 60 calculates the difference (fₜ−fₜ₋₁) between the operating frequencies at a predetermined period of time (T), for example, 30 seconds, from an initiation point of time (t0) at which the vessel (C) is placed and a cooking, such as boiling water, starts (135). Referring to FIG. 6B, when it is assumed that the initiation point of time (t0) is 0 sec and t1 is 30 seconds, the control unit 60 calculates the difference between the operating frequency of t1 and the operating frequency of t0 at the point of time t1 (30 seconds), and calculates the difference between the operating frequency of t2 and the operating frequency of t1 at the point of time t2 (60 seconds).

Then, the control unit 60 determines whether the calculated difference between the operating frequencies is equal to or below a predetermined value (140). The predetermined value represents a reference value used to detect whether water in the vessel (C) is boiling, and corresponds to a difference between the operating frequencies in a state that water is boiling.

The calculated difference between the operating frequencies is equal to or below the predetermined value corresponding to “yes” in operation 140, the control unit 60 detects a water boiling at the present time at which the difference between the operating frequencies is calculated to be equal to or below the predetermined value, and sends the driving unit 50 a control signal at the same time of the detection such that the output level of the heating coil (L) is automatically adjusted. In a case that a user inputs a desired output level through the adjustment (+/−) button 83 after manipulating the water boiling button 85, and if the water boiling is detected, the output level of the heating coil (L) is automatically adjusted to the desired output level. In addition, in a case that a user manipulates the water boiling button 83 without input a desired output level, and if the water boiling is detected, the output level of the heating coil (L) may be adjusted to the minimum output level (level 1) (145).

Then, the control unit 60 sends the main micom 70 a result about detecting the water boiling. The main micom 70 having received the result about detecting the water boiling notifies a user that water in the vessel (C) is boiling such that the user inputs a cooking function stop command by making an alarming or flickering a lamp (150).

Meanwhile, if the calculated difference between the operating frequencies exceeds the predetermined value corresponding to “no” in operation 140, the control unit 60 determines that water is not boiling yet and returns to operation 125 to keep controlling the cooking operation.

Thereafter, the main micom 70 determines whether a cooking function stop signal, that is, a power off signal is input by a user through the manipulation of the power ON/OFF button 81 (155).

If the cooking function stop signal is input by the user through the manipulation of the power ON/OFF button 81, the main micom 70 turns off the induction heating cooker and stops cooking, such as boiling water.

Although a few embodiments of the present disclosure have been shown and described, it would be appreciated by those skilled in the art that changes may be made in these embodiments without departing from the principles and spirit of the invention, the scope of which is defined in the claims and their equivalents.

What is claimed is:

1. An induction heating cooker comprising:
a heating coil;
an inverter unit configured to provide a high-frequency power to the heating coil;
a driving unit configured to provide a signal used to control an operation of the inverter unit;
a operation unit comprising a water boiling button configured to select a water boiling function; and
a control unit configured, if a water boiling function selection signal is input through manipulation of the water boiling button, to vary an operating frequency of the driving unit based on an output of the heating coil, and to determine whether water contained in a vessel placed on the heating coil is boiling by use of a difference between the operating frequencies, the difference calculated at a predetermined period of time.

2. The induction heating cooker of claim 1, wherein the control unit determines that the water contained the vessel is boiling, if a difference between the operating frequencies is equal to or below a predetermined value.

3. The induction heating cooker of claim 2, wherein the predetermined value corresponds to a difference between the operating frequencies obtained when water is boiling.

4. The induction heating cooker of claim 2, wherein the control unit turns down an output level of the heating coil by transmitting a control signal to the driving unit if it is determined that the water contained in the vessel is boiling.

5. The induction heating cooker of claim 2, wherein the control unit stops operating the heating coil by transmitting a control signal to the driving unit if it is determined that the water contained in the vessel is boiling.

6. The induction heating cooker of claim 1, further comprising a detection unit configured to detect an electric current value flowing through the heating coil, wherein the control unit varies the operating frequency of the driving unit based on the detected electric current value.

7. A method of controlling an induction heating cooker comprising a heating coil, an inverter unit configured to provide a high-frequency power to the heating coil and a driving unit configured to provide a signal used to control an operation of the inverter unit, the method comprising:
providing a high-frequency power to the heating coil if a water boiling function selecting signal is input;
detecting a value of an electric current flowing through the heating coil;
varying an operating frequency of the driving unit based on the detected electric current value;
calculating a difference between the operating frequencies at a predetermine period of time;
determining whether water contained in a vessel placed on the heating coil is boiling by use of a difference between the operating frequencies.

8. The method of claim 7, wherein in the determining whether water contained in the vessel is boiling, it is determined that water contained in the vessel is boiling if a difference between the operating frequencies is equal to or below a predetermined value.

9. The method of claim 8, wherein the predetermined value corresponds to a difference between the operating frequencies obtained when water is boiling.

10. The method of claim 8, further comprising turning down an output level of the heating coil by transmitting a control signal to the driving unit if it is determined that the water contained in the vessel is boiling.

11. The method of claim 8, further comprising stopping operation of the heating coil by transmitting a control signal to the driving unit if it is determined that the water contained in the vessel is boiling.

12. The method of claim 10, further comprising notifying a user that the water contained in the vessel is boiling.

13. A method of determining if water in a vessel placed on a heating coil of an induction heating cooker is boiling, the method comprising:
detecting a value of an electric current flowing through the heating coil;
varying an operating frequency of the electric current based on the detected electric current value;
calculating a difference between the operating frequencies at a predetermine period of time;
determining whether the water in the vessel is boiling by use of a difference between the operating frequencies.

14. The method of claim 13, wherein determining whether the water in the vessel is boiling comprises determining that water contained in the vessel is boiling if a difference between the operating frequencies is equal to or below a predetermined value.

15. The method of claim 14, wherein the predetermined value corresponds to a difference between the operating frequencies obtained when water is boiling.

16. The method of claim 14, further comprising turning down an output level of the heating coil if it is determined that the water contained in the vessel is boiling.

17. The method of claim 14, further comprising stopping operation of the heating coil if it is determined that the water contained in the vessel is boiling.

18. The method of claim 17, further comprising notifying a user that the water in the vessel is boiling.
